(19) United States
(12) Patent Application Publication
(10) Pub. No.: US 2020/0041979 A1
(43) Pub. Date: Feb. 6, 2020

(54) SIMULATION APPARATUS, SIMULATION METHOD, AND SIMULATION PROGRAM

(71) Applicant: KOMATSU INDUSTRIES CORPORATION, Kanazawa-shi, Ishikawa (JP)

(72) Inventor: Yukihiro YAMADA, Nomi-gun, Ishikawa (JP)

(73) Assignee: KOMATSU INDUSTRIES CORPORATION, Kanazawa-shi, Ishikawa (JP)

(21) Appl. No.: 16/338,544

(22) PCT Filed: Nov. 2, 2017
(86) PCT No.: PCT/JP2017/039700

§ 371 Date: Apr. 1, 2019

(30) Foreign Application Priority Data
Dec. 16, 2016 (JP) 2016-244543

(51) Int. Cl. G05B 19/4069; B21D 43/05; G06F 17/50; B30B 15/14

(52) U.S. Cl. CPC G05B 19/4069; B21D 43/05; G05B 2219/45142; B30B 15/146; G06F 17/5009

(57) ABSTRACT

A simulation apparatus is configured to simulate a conveyance line. The simulation apparatus includes: a shape model generating unit configured to generate a shape model of each press machine, the conveyance apparatus, and the work; an operation simulation unit configured to perform an operation simulation based on an operation pattern in which the work is conveyed; and an interference check unit configured to execute an interference check based on the simulation by the operation simulation unit. The shape model generating unit is configured to generate a shape model that combines the conveyance apparatus and the work. The simulation apparatus further includes a switching setting unit configured to switch between displaying/hiding of the work in the shape model. The interference check unit is configured to execute a check for interference between the shape model according to the work switching by the switching setting unit, and the press machine.

### TECHNICAL FIELD

The present invention relates to a simulation apparatus, a simulation method, and a simulation program, and particularly to a simulation of press line.

### BACKGROUND ART

In recent years, a tandem press line has been introduced as a press machine for shaping a motor vehicle body, instead of a large-sized transfer press. In the tandem press line, for example, three to five press machines are installed in line, with conveyance apparatuses being provided between the press machines to convey a work under shaping. The machines and apparatuses collaboratively operate for pressing. As the conveyance apparatuses, general-purpose robots are used, for example.

In order to shorten the cycle time of conveyance, each conveyance apparatus, when advancing into or removing from a press machine, is preferably controlled to move along locations at the shortest possible buffer distance from the press machine. In this case, the conveyance line and conveyance timing of the conveyance apparatus are determined conventionally by repeated trial and error to prevent interference with a metallic mold or peripheral devices (such as an upright, a damper, and an oil pan). This disadvantageously requires massive time to determine the optimal conveyance line and conveyance timing. Accordingly, the attempts to shorten the cycle time have been made, such as determining the conveyance line and conveyance timing based on typical patterns or based on designers' experience. These attempts, however, have not necessarily provided the optimal solution.

Under such circumstances, using a simulator has been proposed. The simulator determines whether interference will occur between a press-side member and a conveyor-side member, thereby enabling easy selection of the conveyance line and conveyance timing as described above (see, for example, Japanese Patent Laying-Open No. 2009-22996 [PTL 1]).

### CITATION LIST

### Patent Literature

PTL 1: Japanese Patent Laying-Open No. 2009-22996

### SUMMARY OF INVENTION

### Technical Problem

The above-described press apparatus disclosed in PTL 1 uses a method in which possible interference between a press-side member and a conveyor-side member is checked beforehand in a virtual space.

In this respect, simulating collaborative operation between a plurality of press apparatuses and a plurality of conveyance apparatuses disadvantageously requires massive, complicated computing.

An object of the present invention, which has been made in view of the above respects, is to provide a simulation apparatus, a simulation method, and a simulation program that can execute a check for interference by a simple method.

### Solution to Problem

A simulation apparatus according to one aspect is a simulation apparatus configured to simulate a conveyance line including a conveyance apparatus configured to convey a work between adjacent press machines. The simulation apparatus comprises an operation simulation unit, an interference check unit, a shape model generating unit, and a switching setting unit. The operation simulation unit is configured to simulate operations of each of the press machines, the conveyance apparatus, and the work. The interference check unit is configured to determine whether there is interference. The shape model generating unit is configured to generate a shape model that combines the conveyance apparatus and the work. The switching setting unit is configured to switch between displaying/hiding of the work in the shape model. The interference check unit is configured to determine whether there is interference between the shape model and the press machine and, when the work is hidden, determine that there is no interference with the work.

Preferably, the interference check unit is configured to, when the work is displayed, determine whether there is interference with the shape model including the work.

Preferably, the interference check unit is configured to, when a first conveyance apparatus carries the work into the press machine in a first conveyance line, determine whether there is interference between a first shape model in which the work is displayed, and the press machine.

Preferably, the interference check unit is configured to, when a first conveyance apparatus removes from the press machine in a first conveyance line, determine whether there is interference between a first shape model in which the work is hidden, and the press machine.

Preferably, the interference check unit is configured to, when a second conveyance apparatus enters the press machine in a second conveyance line different from the first conveyance line, determine whether there is interference between a second shape model in which the work is hidden, and the press machine.

Preferably, the interference check unit is configured to, when the second conveyance apparatus carries the work out of the press machine in the second conveyance line, determine whether there is interference between the second shape model in which the work is displayed, and the press machine.

Preferably, the work in the first shape model and the work in the second shape model are different from each other.

Preferably, the shape model generating unit is configured to generate a press shape model that combines the press machine and the work. The switching setting unit is configured to switch between displaying/hiding of the work in the press shape model.

Preferably, the shape model generating unit is configured to generate: a first press shape model that combines the press machine before pressing and a first work; and a second press shape model that combines the press machine after pressing and a second work.

Preferably, the shape model generating unit is configured to generate a three-dimensional shape model of the press machine, the conveyance apparatus, and the work.

A simulation method according to one aspect is a simulation method for simulating a conveyance line including a conveyance apparatus configured to convey a work between adjacent press machines. The simulation method comprises: simulating operations of each of the press machines, the conveyance apparatus, and the work; determining whether there is interference; generating a shape model that combines the conveyance apparatus and the work; and switching between displaying/hiding of the work in the shape model. The determining of whether there is interference includes determining whether there is interference between the shape model and the press machine and, when the work is hidden, determining that there is no interference with the work.

A simulation program according to one aspect is a simulation program executable on a computer of a simulation apparatus configured to simulate a conveyance line including a conveyance apparatus configured to convey a work between adjacent press machines. The simulation program causes the computer to function as: an operation simulation unit configured to simulate operations of each of the press machines, the conveyance apparatus, and the work; an interference check unit configured to determine whether there is interference; a shape model generating unit configured to generate a shape model that combines the conveyance apparatus and the work; and a switching setting unit configured to switch between displaying/hiding of the work in the shape model. The interference check unit is configured to determine whether there is interference between the shape model and the press machine and, when the work is hidden, determine that there is no interference with the work.

### Advantageous Effects of Invention

The present invention can execute a check for interference by a simple method.

### BRIEF DESCRIPTION OF DRAWINGS

FIG. 1 is a diagram showing the outline of a press system 1 based on embodiment 1.

FIG. 2 is a diagram showing functional blocks of a press apparatus 2 and a conveyance apparatus 3 controlled by a controller 9 based on an embodiment.

FIG. 3 is a diagram showing the hardware configuration of a simulation apparatus 10 based on an embodiment.

FIG. 4 is a block diagram showing the functions of simulation apparatus 10 based on an embodiment.

FIG. 5 is a diagram showing an operation simulation of the virtual space in simulation apparatus 10.

FIG. 6 is another diagram showing an operation simulation of the virtual space in simulation apparatus 10.

FIG. 7 is a diagram showing one example of a shape model generated by a shape model generating unit 120 based on an embodiment.

FIG. 8 is a diagram showing another example of a shape model generated by shape model generating unit 120 based on an embodiment.

FIG. 9 is a diagram showing command information for shape models MD based on an embodiment.

FIG. 10 is a diagram showing a flow of executing a simulation process based on an embodiment.

FIG. 11 is a diagram showing another flow of executing a simulation process for a conveyance apparatus based on an embodiment.

FIG. 12 is a diagram showing other command information for shape models MD based on an embodiment.

FIG. 13 is a diagram showing a flow of executing a simulation process for a press apparatus based on an embodiment.

FIG. 14 is a flowchart showing an interference check process in an interference check unit 124 based on an embodiment.

### DESCRIPTION OF EMBODIMENTS

An embodiment is hereinafter described with reference to the drawings. In the following description, identical components are identically denoted. They have the same names and functions. Therefore, the detailed explanation for such components will not be repeated.

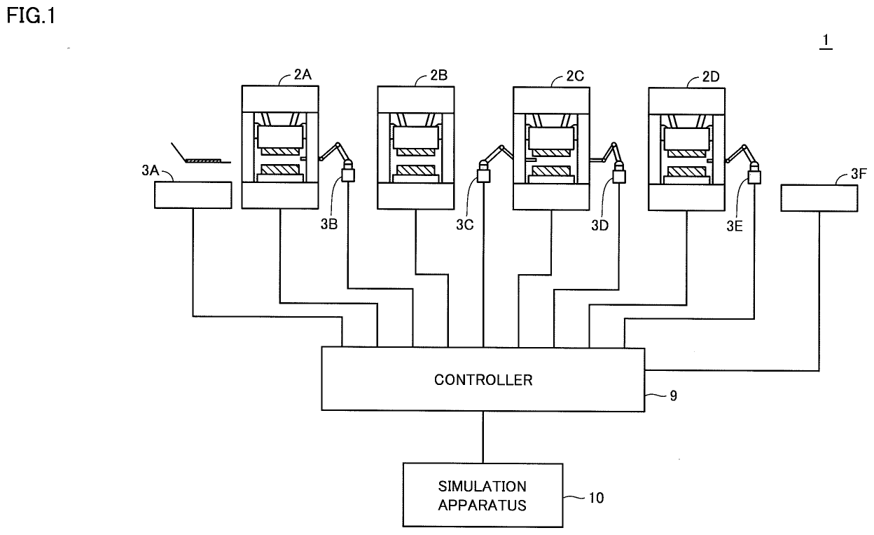

FIG. 1 is a diagram showing the outline of press system 1 based on embodiment 1.

As shown in FIG. 1, press system 1 includes a plurality of press apparatuses 2A, 2B, 2C, 2D (also generically referred to as press apparatus 2) spaced from each other and configured to execute a press operation on a workpiece (work); conveyance apparatuses 3A, 3B, 3C, 3D, 3E, 3F (also generically referred to as conveyance apparatus 3) disposed on both sides of corresponding one of press apparatuses 2A to 2D and configured to convey a workpiece to adjacent press apparatus 2; a controller 9 configured to control those apparatuses; and a simulation apparatus 10. A configuration of a tandem press line is described by way of example.

Controller 9 includes a memory to store a control program that defines an operation procedures of press apparatuses 2A, 2B, 2C, 2D and conveyance apparatuses 3A, 3B, 3C, 3D, 3E, 3F. Controller 9 outputs a control signal to press apparatuses 2A, 2B, 2C, 2D and conveyance apparatuses 3A, 3B, 3C, 3D, 3E, 3F.

Provided is a manipulation device (e.g. a manipulation panel) manipulable by an operator so that the operator can instruct the operation of the tandem press line. The manipulation device outputs a manipulation signal according to the manipulation to controller 9. Receiving the manipulation signal, controller 9 executes the control program based on the manipulation signal and outputs various types of control signals.

Simulation apparatus 10 is an apparatus to simulate the tandem press line in a virtual space. The present example describes a configuration in which simulation apparatus 10 and controller 9 are separately provided. However, simulation apparatus 10 and controller 9 may be configured as a united body.

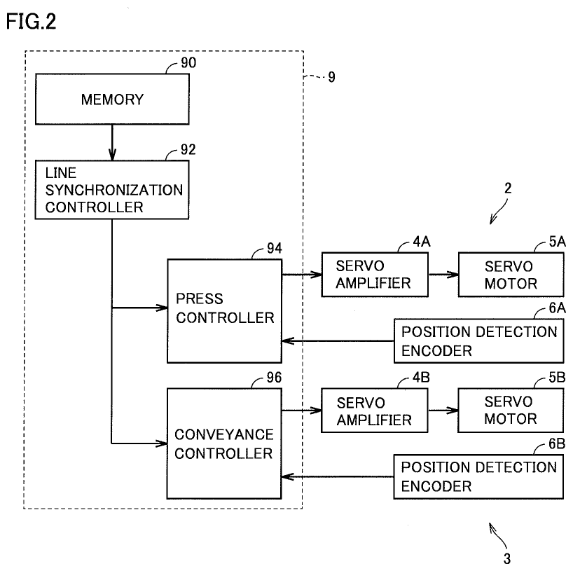

FIG. 2 is a diagram showing functional blocks of press apparatus 2 and conveyance apparatus 3 controlled by controller 9 based on an embodiment.

As shown in FIG. 2, controller 9 includes a memory 90, a line synchronization controller 92, a press controller 94, and a conveyance controller 96.

Press apparatus 2 has a servo amplifier 4A, a servo motor 5A, and a position detection encoder 6A.

Conveyance apparatus 3 has a servo amplifier 4B, a servo motor 5B, and a position detection encoder 6B.

Memory 90 stores a control program that defines the operation procedures of press apparatus 2 and conveyance apparatus 3.

Line synchronization controller 92 outputs a command to press controller 94 and conveyance controller 96 based on the control program stored in memory 90.

Press controller 94 controls press apparatus 2 in accordance with the command from line synchronization controller 92. Press controller 94 executes a press operation by driving servo motor 5A via servo amplifier 4A. Press controller 94 executes position control for the press operation based on the data from position detection encoder 6A.

Conveyance controller 96 executes a conveyance operation by driving servo motor 5B via servo amplifier 4B. Conveyance controller 96 executes position control for the conveyance operation based on the data from position detection encoder 6B.

The present example describes a configuration in which controller 9 includes a single press controller 94 and a single conveyance controller 96. However, press controller 94 may be provided for each press apparatus 2, and conveyance controller 96 may be provided for each conveyance apparatus 3. Alternatively, a single press controller 94 may control all press apparatuses 2, and a single conveyance controller 96 may control all conveyance apparatuses 3.

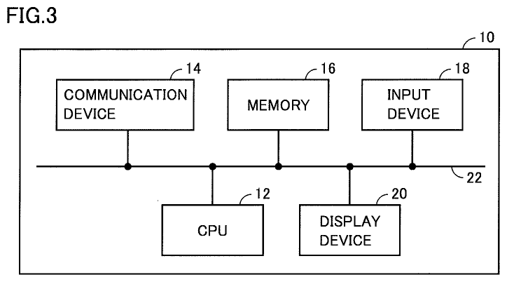

FIG. 3 is a diagram showing the hardware configuration of simulation apparatus 10 based on an embodiment.

As shown in FIG. 3, simulation apparatus 10 includes a central processing unit (CPU) 12, a communication device 14, a memory 16, an input device 18, a display device 20; and an internal bus 22.

Internal bus 22 is connected to each device and allows the devices to exchange data.

Input device 18 includes a keyboard, a mouse, and the like.

Memory 16 stores various types of programs for executing a simulation process in simulation apparatus 10. Memory 16 also includes the program for executing the interference check process in the virtual space described later.

Communication device 14 is used to communicate with controller 9. Communication device 14 may also exchange data with an external server through a network.

Display device 20 is, for example, a liquid crystal display (LCD).

CPU 12 controls the overall simulation apparatus 10. CPU 12 implements various types of functions by executing the programs stored in memory 16.

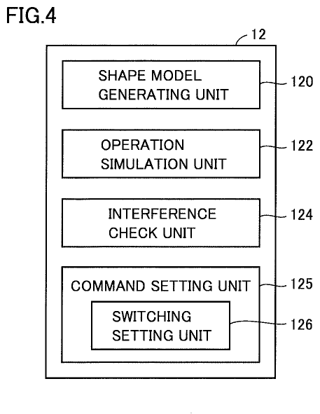

FIG. 4 is a block diagram showing the functions of simulation apparatus 10 based on an embodiment.

As shown in FIG. 4, simulation apparatus 10 implements various types of functional blocks by CPU 12 executing the programs stored in memory 16.

CPU 12 includes a shape model generating unit 120, an operation simulation unit 122, an interference check unit 124, and a command setting unit 125. Command setting unit 125 includes a switching setting unit 126.

Shape model generating unit 120 generates a shape model to execute an operation simulation in the virtual space.

Command setting unit 125 sets a command for executing an operation simulation of the generated shape model. The command is set by an operator via input device 18. Switching setting unit 126 sets switching between displaying/hiding of a part of a shape model in the virtual space.

Operation simulation unit 122 executes an operation simulation, in the virtual space, of press apparatus 2 and conveyance apparatus 3 which constitute the above-described tandem press line.

Interference check unit 124 determines whether press apparatus 2 and conveyance apparatus 3 will interfere with each other, based on the operation simulation in the virtual space in operation simulation unit 122.

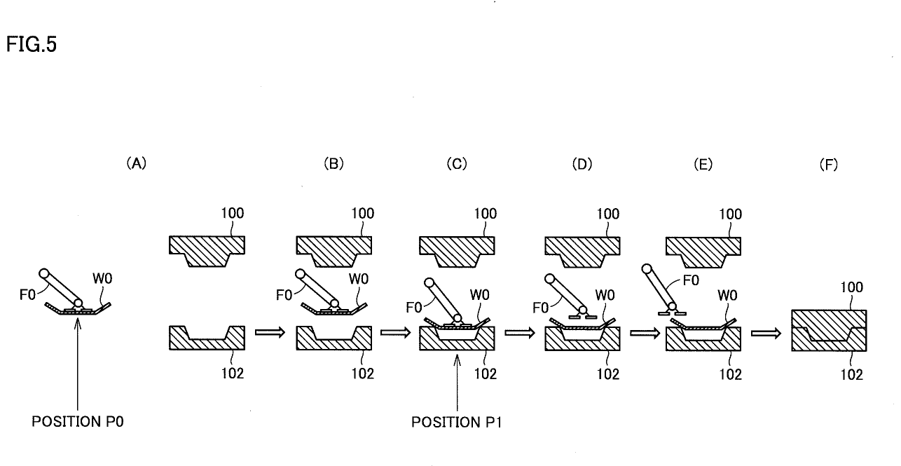

FIG. 5 is a diagram showing an operation simulation of the virtual space in simulation apparatus 10.

FIG. 5(A) to FIG. 5(F) show a series of conveyance and press processes (first conveyance line).

The present example shows a process in which a feeder (conveyance apparatus) F0 carries a workpiece W0 into a press apparatus. The press apparatus includes an upper metallic mold 100 and a lower metallic mold 102. Feeder F0 conveys workpiece W0 from a predetermined position P0 to a predetermined position P1 at which feeder F0 places workpiece W0 on lower metallic mold 102, so that workpiece W0 can be pressed at the press apparatus. After conveying workpiece W0, feeder F0 returns from predetermined position P1 to predetermined position P0, and again carries the next workpiece W0 into the press apparatus. This process is repeated.

FIG. 5(A) shows a state in which feeder F0 holds and carries workpiece W0 from predetermined position P0 into the press apparatus including upper metallic mold 100 and lower metallic mold 102.

FIG. 5(B) shows a state in which feeder F0 holding workpiece W0 has entered the press apparatus.

FIG. 5(C) shows a state in which feeder F0 has brought workpiece W0 to predetermined position P1 in press apparatus 2.

FIG. 5(D) and FIG. 5(E) show a process in which feeder F0 returns to predetermined position P0.

FIG. 5(F) shows a state in which the press apparatus is executing a press process by fitting upper metallic mold 100 and lower metallic mold 102 to each other.

As an operation simulation, the cycle time of conveyance is checked, and it is also checked whether there is interference between feeder F0 and the press apparatus.

Specifically, for a conveyance process from predetermined position P0 to predetermined position P1, it is checked whether there is interference between feeder F0 which is holding workpiece W0, and the press apparatus.

For a conveyance process from predetermined position P1 to predetermined position P0, it is checked whether there is interference between feeder F0 which is not holding workpiece W0, and the press apparatus.

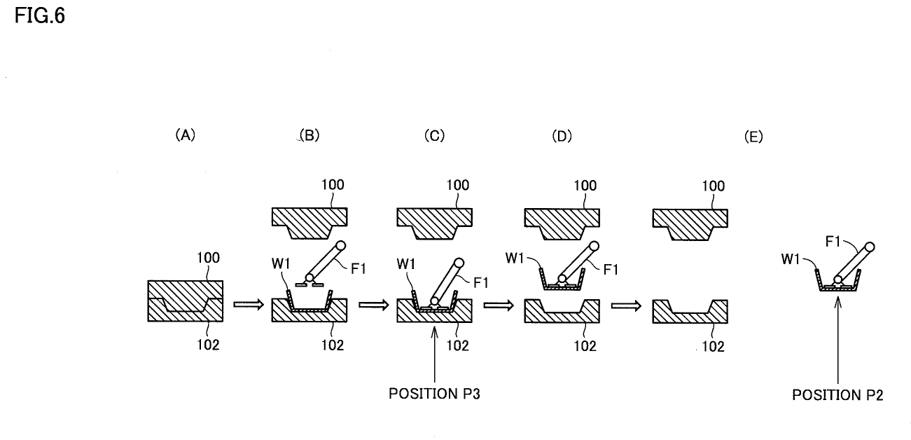

FIG. 6 is another diagram showing an operation simulation of the virtual space in simulation apparatus 10.

FIG. 6(A) to FIG. 6(F) show a series of conveyance and press processes (second conveyance line).

The present example shows a process in which a feeder F1 carries a workpiece W1 out of a press apparatus. A press process at the press apparatus has changed workpiece W0 in shape into workpiece W1.

The press apparatus includes upper metallic mold 100 and lower metallic mold 102. Feeder F1 moves from a predetermined position P2 to a predetermined position P3 at which workpiece W1 is placed, so that feeder F1 can carry workpiece W1 out.

Feeder F1 picks up workpiece W1 at predetermined position P3 and conveys workpiece W1 from predetermined position P3 to predetermined position P2. After conveying workpiece W1, feeder F1 again moves from predetermined position P2 to predetermined position P3 in the press apparatus for carrying the next workpiece out. The process is repeated.

FIG. 6(A) shows a state in which press apparatus 2 is executing a press process. As described above, the press process changes workpiece W0 in shape into workpiece W1.

FIG. 6(B) shows a state in which feeder F1 has moved from predetermined position P2 and has entered the press apparatus for carrying workpiece W1 out.

FIG. 6(C) shows a state in which feeder F1 has reached predetermined position P3 at which workpiece W1 is placed.

FIG. 6(D) and FIG. 5 (E) show a process in which feeder F1 returns to predetermined position P2 while holding workpiece W1.

As an operation simulation, the cycle time of the carrying-out is checked, and it is also checked whether there is interference between feeder F1 and the press apparatus.

Specifically, for a conveyance process from predetermined position P2 to predetermined position P3, it is checked whether there is interference between feeder F0 which is not holding workpiece W1, and the press apparatus.

For a conveyance process from predetermined position P3 to predetermined position P2, it is checked whether there is interference between feeder F1 which is holding workpiece W1, and the press apparatus.

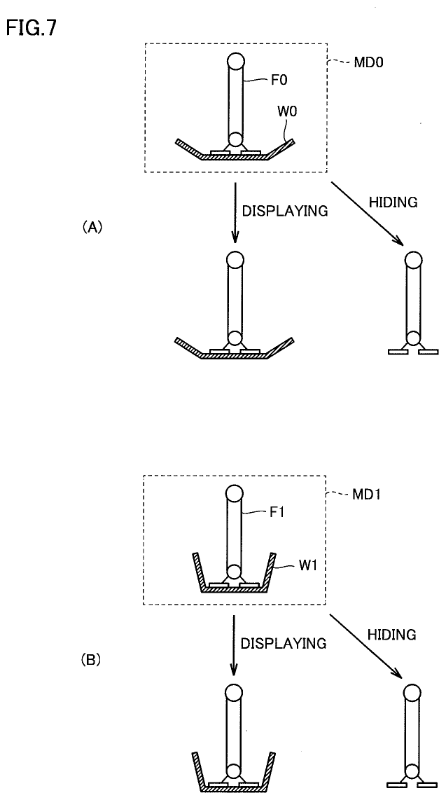

FIG. 7 is a diagram showing one example of a shape model generated by shape model generating unit 120 based on an embodiment.

FIG. 7 (A) shows a shape model MD0 of conveyance apparatus 3. Shape model MD0 includes feeder F0 and workpiece W0. Shape model MD0 is shown with feeder F0 and workpiece W0 being combined. That is, the state in which feeder F0 is holding workpiece W0 is shown. The shape model is also generically referred to as shape model MD. As to the generation of shape model MD, shape model generating unit 120 may directly generate a model that combines the feeder and the workpiece, or may separately generate models of the feeder and the workpiece and then generate a model that combines the feeder and the workpiece.

In the present example, switching setting unit 126 executes a setting process to switch between displaying/hiding for a part of the shape model in the virtual space.

Specifically, in the present example, switching setting unit 126 executes a process to set the switching between displaying/hiding for workpiece W0 in shape model MD0.

For example, in the case of displaying, shape model MD0 is shown with feeder F0 and workpiece W0 both being displayed. That is, the state in which feeder F0 is holding workpiece W0 is shown.

In the case of hiding, on the other hand, shape model MD0 is shown with feeder F0 being displayed, but without workpiece W0. That is, the state in which feeder F0 is not holding workpiece W0 is shown.

FIG. 7 (B) shows a shape model MD1 of conveyance apparatus 3. Shape model MD1 includes feeder F1 and workpiece W1. Shape model MD1 is shown with feeder F1 and workpiece W1 being combined. That is, the state in which feeder F1 is holding workpiece W1 is shown.

In the present example, switching setting unit 126 executes a setting process to switch between displaying/hiding for a part of the shape model in the virtual space.

Specifically, in the present example, switching setting unit 126 executes a process to set the switching between displaying/hiding for workpiece W1 in shape model MD1.

For example, in the case of displaying, shape model MD1 is shown with feeder F1 and workpiece W1 both being displayed. That is, the state in which feeder F1 is holding workpiece W1 is shown.

In the case of hiding, on the other hand, shape model MD1 is shown with feeder F1 being displayed, but without workpiece W1. That is, the state in which feeder F1 is not holding workpiece W1 is shown.

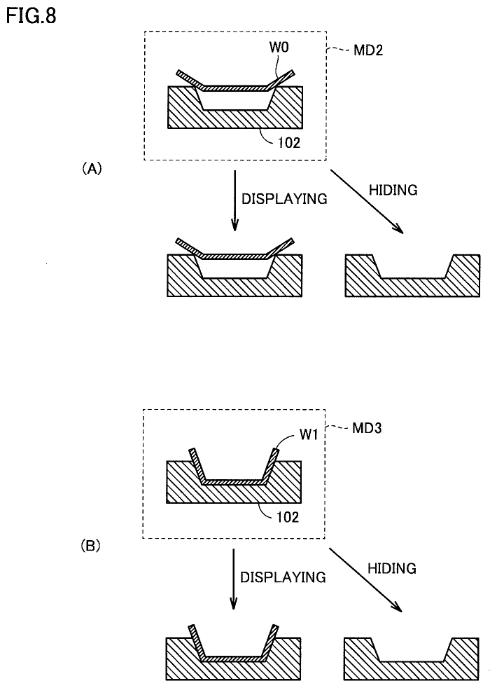

FIG. 8 is a diagram showing another example of a shape model generated by shape model generating unit 120 based on an embodiment.

FIG. 8 (A) shows a shape model MD2 of press apparatus 2. In the present example, only a lower metallic mold that constitutes a part of press apparatus 2 is shown as a shape model of press apparatus 2 by way of example. The shape model, however, may also include an upper metallic mold and/or another component of another press apparatus.

Shape model MD2 includes lower metallic mold 102 and workpiece W0. Shape model MD2 is shown with lower metallic mold 102 and workpiece W0 being combined. That is, the state in which workpiece W0 is placed on lower metallic mold 102 is shown.

In the present example, switching setting unit 126 executes a setting process to switch between displaying/hiding for a part of the shape model in the virtual space.

Specifically, in the present example, switching setting unit 126 executes a process to set the switching between displaying/hiding for workpiece W0 in shape model MD2.

For example, in the case of displaying, shape model MD2 is shown with lower metallic mold 102 and workpiece W0 both being displayed. That is, the state in which workpiece W0 is placed on lower metallic mold 102 is shown.

In the case of hiding, on the other hand, shape model MD2 is shown with lower metallic mold 102 being displayed, but without workpiece W0. That is, the state in which workpiece W0 is not placed on lower metallic mold 102 is shown.

FIG. 8 (B) shows a shape model MD3 of press apparatus 2. In the present example, only a lower metallic mold that constitutes a part of press apparatus 2 is shown as a shape model of press apparatus 2 by way of example. The shape model, however, may also include another component.

Shape model MD3 includes lower metallic mold 102 and workpiece W1. Shape model MD3 is shown with lower metallic mold 102 and workpiece W1 being combined. That is, the state in which workpiece W1 is placed on lower metallic mold 102 is shown.

In the present example, switching setting unit 126 executes a setting process to switch between displaying/hiding for a part of the shape model in the virtual space.

Specifically, in the present example, switching setting unit 126 executes a process to set the switching between displaying/hiding for workpiece W1 in shape model MD3.

For example, in the case of displaying, shape model MD3 is shown with lower metallic mold 102 and workpiece W1 both being displayed. That is, the state in which workpiece W1 is placed on lower metallic mold 102 is shown.

In the case of hiding, on the other hand, shape model MD3 is shown with lower metallic mold 102 being displayed, but without workpiece W1. That is, the state in which workpiece W1 is not placed on lower metallic mold 102 is shown.

In the present embodiment, an operation simulation is executed using shape model MD generated by the above-described shape model generating unit 120.

[Process in Conveyance Apparatus]

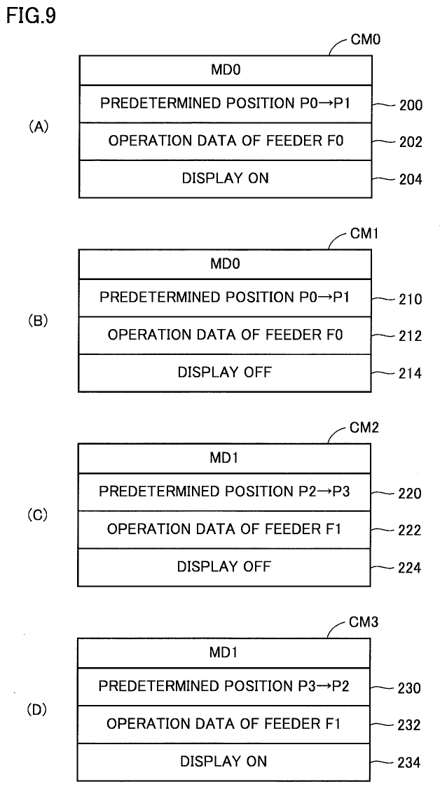

FIG. 9 is a diagram showing command information for shape models MD based on an embodiment.

FIG. 9 (A) and FIG. 9 (B) respectively show two pieces of command information CM0, CM1 to be given to shape model MD0. The command information is preset by command setting unit 125.

FIG. 9 (C) and FIG. 9 (D) respectively show two pieces of command information CM2, CM3 to be given to shape model MD1.

With reference to FIG. 9 (A), command information CM0 includes a movement instruction 200 to move shape model MD0 from predetermined position P0 to predetermined position P1, operation data 202 of feeder F0, and display flag data 204.

By way of example, the position is two-dimensional data using the X-axis and the Y-axis. Predetermined position P0 is set to the initial position of feeder F0. Specifically, Predetermined position P0 is set to the starting position at which feeder F0 starts holding workpiece W0. Predetermined position P1 is set to the position at which feeder F0 ends the hold of workpiece W0.

In accordance with movement instruction 200, shape model MD0 executes a moving process from predetermined position P0 to predetermined position P1. Based on operation data 202, the operation motion during the moving process of feeder F0 is defined.

Display flag data 204 is the data defined in accordance with the switching instruction from switching setting unit 126 and is the data which sets displaying/hiding for a part of the shape model switchable between displaying/hiding. In the present example, display ON is set, by way of example. Accordingly, in the virtual space, workpiece W0 is displayed along with feeder F0.

With reference to FIG. 9 (B), command information CM1 includes a movement instruction 210 to move shape model MD0 from predetermined position P1 to predetermined position P0, operation data 212 of feeder F0, and display flag data 214.

In accordance with movement instruction 210, shape model MD0 executes a moving process from predetermined position P1 to predetermined position P0. Based on operation data 212, the operation motion during the moving process of feeder F0 is defined.

Display flag data 214 is the data defined in accordance with the switching instruction from switching setting unit 126 and is the data which sets displaying/hiding for a part of the shape model switchable between displaying/hiding. In the present example, display OFF is set. Accordingly, in the virtual space, feeder F0 is displayed, but without workpiece W0.

With reference to FIG. 9 (C), command information CM2 includes a movement instruction 220 to move shape model MD1 from predetermined position P2 to predetermined position P3, operation data 222 of feeder F1, and display flag data 224.

Predetermined position P2 is set to the initial position of feeder F1. Predetermined position P2 is set to the starting position from which feeder F1 starts for carrying workpiece W1 out, and the ending position at which feeder F1 ends the hold of workpiece W1. Predetermined position P3 is set to the starting position at which feeder F1 starts holding workpiece W1.

In accordance with movement instruction 220, shape model MD1 executes a moving process from predetermined position P2 to predetermined position P3. Based on operation data 222, the operation motion during the moving process of feeder F1 is defined.

Display flag data 224 is the data defined in accordance with the switching instruction from switching setting unit 126 and is the data which sets displaying/hiding for a part of the shape model switchable between displaying/hiding. In the present example, display OFF is set, by way of example. Accordingly, in the virtual space, feeder F1 is displayed, but without workpiece W1.

With reference to FIG. 9 (D), command information CM3 includes a movement instruction 230 to move shape model MD1 from predetermined position P3 to predetermined position P2, operation data 232 of feeder F1, and display flag data 234.

In accordance with movement instruction 230, shape model MD1 executes a moving process from predetermined position P3 to predetermined position P2. Based on operation data 232, the operation motion during the moving process of feeder F1 is defined.

Display flag data 234 is the data defined in accordance with the switching instruction from switching setting unit 126 and is the data which sets displaying/hiding for a part of the shape model switchable between displaying/hiding. In the present example, display ON is set, by way of example. Accordingly, in the virtual space, workpiece W1 is displayed along with feeder F1.

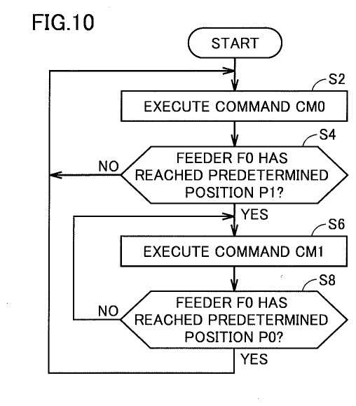

FIG. 10 is a diagram showing a flow of executing a simulation process based on an embodiment. This process is executed mainly in operation simulation unit 122.

As shown in FIG. 10, first, CPU 12 executes command information CM0 (step S2). Specifically, operation simulation unit 122 executes command information CM0. Then, shape model MD0 is displayed in the virtual space and executes a moving process according to the set operation motion. For example, as shown in FIG. 5(A) and FIG. 5(B), feeder F0 executes a moving process from predetermined position P0 to predetermined position P1 while holding workpiece W0.

Next, CPU 12 determines whether feeder F0 has reached predetermined position P1 (step S4). For example, operation simulation unit 122 determines whether feeder F0 has reached, by the moving process, predetermined position P1 at which feeder F0 is to place workpiece W0 on lower metallic mold 102, as in the state shown in FIG. 5(C).

If CPU 12 determines that feeder F0 has reached predetermined position P1 at step S4 (YES at step S4), CPU 12 goes on to step S6.

On the other hand, if CPU 12 determines that feeder F0 has not reached predetermined position P1 at step S4 (NO at step S4), CPU 12 returns to step S2 and continues the execution process of command information CM0.

At step S6, CPU 12 executes command information CM1 (step S6). Specifically, operation simulation unit 122 executes command information CM1. Then, shape model MD0 is displayed in the virtual space and executes a moving process according to the set operation motion. For example, as shown in FIG. 5(D) and FIG. 5(E), feeder F0 executes a moving process from predetermined position P1 to predetermined position P0 without holding workpiece W0.

Next, CPU 12 determines whether feeder F0 has reached predetermined position P0 (step S8). Specifically, operation simulation unit 122 determines whether feeder F0 has reached predetermined position P0, i.e., the initial position, by the moving process.

If CPU 12 determines that feeder F0 has reached predetermined position P0 at step S8 (YES at step S8), CPU 12 goes on to initial step S2.

On the other hand, if CPU 12 determines that feeder F0 has not reached predetermined position P0 at step S8 (NO at step S8), CPU 12 returns to step S6 and continues the execution process of command information CM1.

By this process, from predetermined position P0 to predetermined position P1, feeder F0 executes a moving process while holding workpiece W0, as described with reference to FIG. 5. When returning from predetermined position P1 to predetermined position P0, feeder F0 executes a moving process without holding workpiece W0.

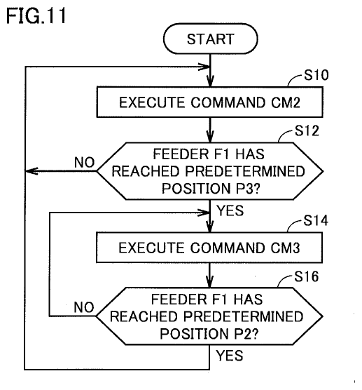

FIG. 11 is a diagram showing another flow of executing a simulation process for a conveyance apparatus based on an embodiment. This process is executed mainly in operation simulation unit 122.

As shown in FIG. 11, first, CPU 12 executes command information CM2 (step S10). Specifically, operation simulation unit 122 executes command information CM2. Then, shape model MD1 is displayed in the virtual space and executes a moving process according to the set operation motion. For example, as shown in FIG. 6(B), feeder F1 executes a moving process from predetermined position P2 to predetermined position P3 without holding workpiece W1.

Next, CPU 12 determines whether feeder F1 has reached predetermined position P3 (step S12). For example, operation simulation unit 122 determines whether feeder F1 has reached, by the moving process, predetermined position P3 at which feeder F1 is to pick up workpiece W1 on lower metallic mold 102, as shown in FIG. 6(C).

If CPU 12 determines that feeder F1 has reached predetermined position P3 at step S12 (YES at step S12), CPU 12 goes on to step S14.

On the other hand, if CPU 12 determines that feeder F1 has not reached predetermined position P3 at step S12 (NO at step S12), CPU 12 returns to step S10 and continues the execution process of command information CM2.

At step S14, CPU 12 executes command information CM3 (step S14). Specifically, operation simulation unit 122 executes command information CM3. Then, shape model MD1 is displayed in the virtual space and executes a moving process according to the set operation motion. For example, feeder F1 executes a moving process from predetermined position P3 to predetermined position P2 while holding workpiece W1, as shown in FIG. 6(D).

Next, CPU 12 determines whether feeder F1 has reached predetermined position P2 (step S16). Specifically, operation simulation unit 122 determines whether feeder F1 has reached predetermined position P2, i.e., the initial position, by the moving process.

If CPU 12 determines that feeder F1 has reached predetermined position P2 at step S16 (YES at step S16), CPU 12 goes on to initial step S10.

On the other hand, if CPU 12 determines that feeder F1 has not reached predetermined position P2 at step S16 (NO at step S16), CPU 12 returns to step S14 and continues the execution process of command information CM3.

By this process, from predetermined position P2 to predetermined position P3, feeder F1 executes a moving process without holding workpiece W1, as described with reference to FIG. 6. When returning from predetermined position P3 to predetermined position P2, feeder F1 executes a moving process while holding workpiece W1.

By this process, a simulation process can be executed using a shape model that combines workpiece W0 and feeder F0, and a shape model that combines workpiece W1 and feeder F1. That is, it is not necessary to define the operations of workpiece W0 and workpiece W1 independently of the operations of feeder F0 and feeder F1, respectively.

[Process in Press Apparatus]

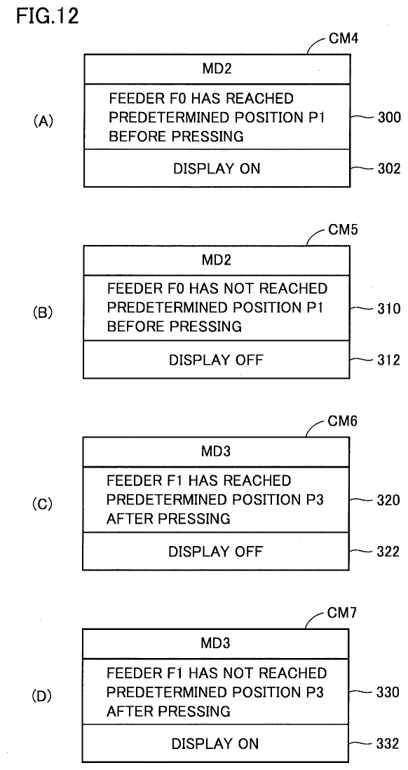

FIG. 12 is a diagram showing other command information for shape model MD based on an embodiment.

FIG. 12 (A) and FIG. 12 (B) respectively show two pieces of command information CM4, CM5 to be given to shape model MD2.

FIG. 12 (C) and FIG. 12 (D) respectively show two pieces of command information CM6, CM7 to be given to shape model MD3. The command information is preset by command setting unit 125.

With reference to FIG. 12 (A), command information CM4 includes condition data 300 for a press apparatus before pressing, and display flag data 302, for shape model MD2.

Condition data 300 is the data which sets the condition for switching the display flag data.

In the present example, the case in which feeder F0 has reached predetermined position P1 before pressing is set as the condition.

Display flag data 302 is the data defined in accordance with the switching instruction from switching setting unit 126 and is the data which sets displaying/hiding for a part of the shape model switchable between displaying/hiding. In the present example, display ON is set. Accordingly, in the virtual space, if feeder F0 has reached predetermined position P1 before pressing, workpiece W0 is displayed along with lower metallic mold 102.

With reference to FIG. 12 (B), command information CM5 includes condition data 310 for a press apparatus before pressing, and display flag data 312, for shape model MD2.

Condition data 310 is the data which sets the condition for switching the display flag data.

In the present example, the case in which feeder F0 has not reached predetermined position P1 before pressing is set as the condition.

Display flag data 312 is the data defined in accordance with the switching instruction from switching setting unit 126 and is the data which sets displaying/hiding for a part of the shape model switchable between displaying/hiding. In the present example, display OFF is set. Accordingly, in the virtual space, only lower metallic mold 102 is displayed until feeder F0 reaches predetermined position P1 before pressing.

With reference to FIG. 12 (C), command information CM4 includes condition data 320 for a press apparatus after pressing, and display flag data 322, for shape model MD3.

Condition data 320 is the data which sets the condition for switching the display flag data.

In the present example, the case in which feeder F1 has reached predetermined position P3 after pressing is set as the condition.

Display flag data 302 is the data defined in accordance with the switching instruction from switching setting unit 126 and is the data which sets displaying/hiding for a part of the shape model switchable between displaying/hiding. In the present example, display ON is set. Accordingly, in the virtual space, if feeder F1 has reached predetermined position P3 after pressing, workpiece W1 is displayed along with lower metallic mold 102.

With reference to FIG. 12 (D), command information CM4 includes condition data 330 for a press apparatus after pressing, and display flag data 332, for shape model MD3.

Condition data 330 is the data which sets the condition for switching the display flag data.

In the present example, the case in which feeder F1 has not reached predetermined position P3 after pressing is set as the condition.

Display flag data 332 is the data defined in accordance with the switching instruction from switching setting unit 126 and is the data which sets displaying/hiding for a part of the shape model switchable between displaying/hiding. In the present example, display OFF is set. Accordingly, in the virtual space, only lower metallic mold 102 is displayed until feeder F1 reaches predetermined position P3 after pressing.

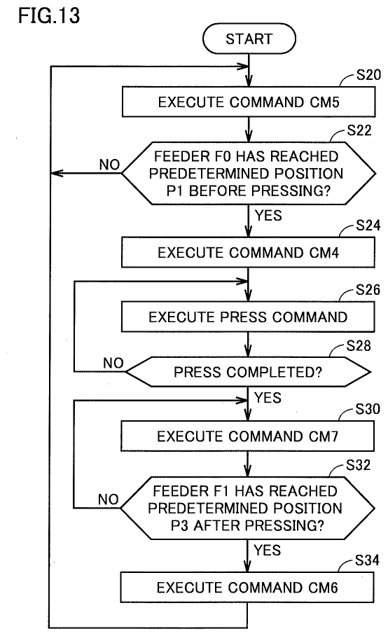

FIG. 13 is a diagram showing a flow of executing a simulation process for a press apparatus based on an embodiment. This process is executed mainly in operation simulation unit 122.

As shown in FIG. 13, first, CPU 12 executes command information CM5 (step S20). Specifically, operation simulation unit 122 executes command information CM5. Then, shape model MD2 is displayed in the virtual space. For example, as shown in FIG. 5(A) and FIG. 5(B), only lower metallic mold 102 is displayed while feeder F0 is moving from predetermined position P0 to predetermined position P1.

Next, CPU 12 determines whether feeder F0 has reached predetermined position P1 (step S22). For example, operation simulation unit 122 determines whether feeder F0 has reached predetermined position P1 at which feeder F0 is to place workpiece W0 on lower metallic mold 102, as shown in FIG. 5(C).

If CPU 12 determines that feeder F0 has reached predetermined position P1 at step S22 (YES at step S22), CPU 12 goes on to step S24.

On the other hand, if CPU 12 determines that feeder F0 has not reached predetermined position P1 at step S22 (NO at step S22), CPU 12 returns to step S20 and continues the execution process of command information CM5.

At step S24, CPU 12 executes command information CM4 (step S24). Specifically, operation simulation unit 122 executes command information CM4. Then, shape model MD2 is displayed in the virtual space. For example, shape model MD2 is displayed with workpiece W0 placed on lower metallic mold 102, as shown in FIG. 5(C) to FIG. 5(E).

Next, CPU 12 executes a press command (step S26). Specifically, operation simulation unit 122 executes a press process to fit upper metallic mold 100 and lower metallic mold 102 to each other, as shown in FIG. 5(F) and FIG. 6(A).

Next, CPU 12 determines whether the press has been completed (step S28).

If CPU 12 determines that the press has not been completed at step S28 (NO at step S28), CPU 12 returns to step S26 and continues executing the press command.

On the other hand, if CPU 12 determines that the press has been completed at step S28 (YES at step S28), CPU 12 executes command information CM7 (step S30). Then, shape model MD3 is displayed in the virtual space. For example, shape model MD3 is displayed with workpiece W1 placed on lower metallic mold 102, as shown in FIG. 6(B).

Next, CPU 12 determines whether feeder F1 has reached predetermined position P3 (step S32). For example, operation simulation unit 122 determines whether feeder F1 has reached predetermined position P3 at which feeder F1 is to pick up workpiece W1 placed on lower metallic mold 102, as shown in FIG. 6(C).

If CPU 12 determines that feeder F1 has reached predetermined position P3 at step S32 (YES at step S32), CPU 12 goes on to step S34.

On the other hand, if CPU 12 determines that feeder F1 has not reached predetermined position P3 at step S32 (NO at step S32), CPU 12 returns to step S30 and continues the execution process of command information CM7.

At step S34, CPU 12 executes command information CM6 (step S34). Specifically, operation simulation unit 122 executes command information CM6. Then, shape model MD3 is displayed in the virtual space. For example, shape model MD3 is displayed with no workpiece W1 on lower metallic mold 102, as shown in FIG. 6(D) to FIG. 6(E).

By this process, before pressing, shape model MD is displayed with no workpiece W0 on lower metallic mold 102 until feeder F0 reaches predetermined position P1, and shape model MD is displayed with workpiece W0 placed on lower metallic mold 102 if feeder F0 has reached predetermined position P1, as shown in FIG. 5.

After pressing, shape model MD is displayed with workpiece W1 placed on lower metallic mold 102 until feeder F1 reaches predetermined position P3, and shape model MD is displayed with no workpiece W1 on lower metallic mold 102 if feeder F1 has reached predetermined position P3, as shown in FIG. 6.

By this process, a simulation process can be executed using a shape model that combines workpiece W0 and lower metallic mold 102, and a shape model that combines workpiece W1 and lower metallic mold 102. Specifically, a shape model that combines workpiece W0 and lower metallic mold 102 and a shape model that combines workpiece W1 and lower metallic mold 102 are generated, and each workpiece W0, W1 is switched between displaying/hiding. This allows easy display of the states of before and after pressing. It is not necessary to independently define the states of workpieces W0, W1. Therefore, the machining state of workpiece W0 can be replaced with that of workpiece W1 by a simple method. This can reduce the processing load of the simulation.

[Interference Check Process]

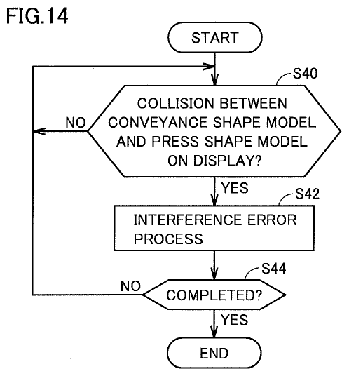

FIG. 14 is a flowchart showing an interference check process in interference check unit 124 based on an embodiment. This process is executed in interference check unit 124. Interference check unit 124 determines whether a press apparatus and a conveyance apparatus will interfere with each other, in accordance with an operation simulation in the virtual space executed by operation simulation unit 122.

As shown in FIG. 14, CPU 12 determines whether there is collision between a shape model of the conveyance apparatus and a shape model of the press apparatus on display (step S40).

Specifically, interference check unit 124 determines whether there is collision between shape model MD0 of the conveyance apparatus and shape model MD2 of the press apparatus, by way of example. If the shape models on display overlap each other when workpiece W0 is conveyed from predetermined position P0 to predetermined position P1 in the moving process shown in FIG. 5(A) to FIG. 5(C), it is determined that there is collision. On the other hand, if the shape models do not overlap each other, it is determined that there is no collision. Also, in the moving process shown in FIG. 5(D) and FIG. 5(E), when shape model MD0 of the conveyance apparatus returns from predetermined position P1 to predetermined position P0, it is determined whether there is collision with shape model MD2 of the press apparatus.

Similarly, interference check unit 124 determines whether there is collision between shape model MD1 of the conveyance apparatus and shape model MD3 of the press apparatus. If the shape models on display overlap each other during movement from predetermined position P2 to predetermined position P3 in the moving process shown in FIG. 6(B) and FIG. 6(C), it is determined that there is collision. On the other hand, if the shape models do not overlap each other, it is determined that there is no collision. Also, in the moving process shown in FIG. 6(D) and FIG. 6(E), when workpiece W1 is conveyed from predetermined position P3 to predetermined position P2, it is determined whether there is collision between shape model MD1 of the conveyance apparatus and shape model MD3 of the press apparatus.

If CPU 12 determines that there is collision at step S40 (YES at step S40), CPU 12 executes an interference error process (step S42). Specifically, interference check unit 124 notifies the presence of collision. For example, the presence of collision may be notified by voice, or by display such as a change of the color, or by stopping the simulation process and explicitly indicating the collision state. The scene of the collision may be saved as data for later use.

Next, at step S44, CPU 12 determines whether the simulation process has been completed. Specifically, interference check unit 124 determines whether the simulation process has been completed.

If CPU 12 determines that the simulation process has been completed at step S44 (YES at step S44), CPU 12 ends the process. On the other hand, if CPU 12 determines that the simulation process has not been completed at step S44 (NO at step S44), CPU 12 returns to step S40 and repeats the above process.

The method makes it possible to simulate the same situation as the actual press line by a simple method by generating a shape model of a conveyance apparatus and a shape model of a press apparatus, and by switching between displaying/hiding of a workpiece. Thus, the interference check process can be executed by a simple method.

Although the present example describes a two-dimensional shape model, the present example is not limited to a two-dimensional shape, but is also applicable to a three-dimensional shape.

As the program in the present embodiment, an application executable on a personal computer may be provided. In this case, the program in the present embodiment may be included as a partial function of various types of application programs executable on the personal computer.

### ADVANTAGEOUS EFFECTS

The advantageous effects of an embodiment will now be described.

Simulation apparatus 10 in an embodiment is a simulation apparatus configured to simulate a conveyance line including conveyance apparatuses 3A to 3E configured to convey a workpiece (work) between adjacent press machines 2A to 2D, as shown in FIG. 1. As shown in FIG. 4, simulation apparatus 10 includes: operation simulation unit 122 configured to simulate the operations of each of the press machines, the conveyance apparatus, and the workpiece; interference check unit 124 configured to determine whether there is interference; shape model generating unit 120 configured to generate shape model MD that combines feeder F and workpiece W; and switching setting unit 126 configured to switch between displaying/hiding of workpiece W in shape model MD. Interference check unit 124 is configured to determine whether there is interference between shape model MID and the press machine and, when workpiece W is hidden, determine that there is no interference with workpiece W.

Generation of shape model MD that combines feeder F and workpiece W for determination of whether there is interference eliminates the need to independently define the operation of workpiece W separately from the operation of feeder F. Thus, the interference check for determining whether there is interference can be executed by a simple method.

Interference check unit 124 is configured to, when workpiece W is displayed, determine whether there is interference with shape model MD including workpiece W.

Switching between displaying/hiding allows easy execution of the interference check for determining whether there is interference with workpiece W.

Interference check unit 124 is configured to, when feeder F0 carries workpiece W0 into a press machine in a first conveyance line, determine whether there is interference between shape model MD0 in which workpiece W0 is displayed, and the press machine.

When workpiece W0 is carried in, generation of shape model MD0 that combines feeder F0 and workpiece W0 for execution of the interference check eliminates the need to independently define the operation of workpiece W0. Thus, the interference check can be executed by a simple method.

Interference check unit 124 is configured to, when feeder F0 removes from a press machine in a first conveyance line, determine whether there is interference between shape model MD0 in which workpiece W0 is hidden, and the press machine.

When feeder F0 returns, shape model MD0 in which workpiece W0 is hidden eliminates the need to independently define the operation of the workpiece. This allows an easy check for interference between feeder F0 and the press machine.

Interference check unit 124 is configured to, when feeder F1 enters a press machine in a second conveyance line different from the first conveyance line, determine whether there is interference between a second shape model in which workpiece W1 is hidden, and the press machine.

When feeder F1 carries a workpiece into a press machine, shape model MD0 in which workpiece W1 is hidden eliminates the need to independently define the operation of the workpiece. This allows an easy check for interference between feeder F1 and the press machine.

Interference check unit 124 is configured to, when feeder F1 carries workpiece W1 out of a press machine in the second conveyance line, determine whether there is interference between shape model MD1 in which workpiece W1 is displayed, and the press machine.

When feeder F1 carries a workpiece out of a press machine, shape model MD0 in which workpiece W1 is displayed eliminates the need to independently define the operation of the workpiece. This allows an easy check for interference between feeder F1 which holds workpiece W1, and the press machine.

Workpiece W0 in shape model MD0 and workpiece W1 in shape model MD1 are different from each other.

The machining state of workpiece W0 can be replaced with that of workpiece W1 by a simple method. This can reduce the processing load of the simulation.

Shape model generating unit 120 is configured to generate shape model MD2 that combines lower metallic mold 102 and workpiece W0, and generate shape model MD3 that combines lower metallic mold 102 and workpiece W1. Switching setting unit 126 is configured to switch between displaying/hiding of workpieces W0, W1 in shape models MD2, MD3. This eliminates the need to independently define the operations of workpieces W0, W1. Thus, the interference check can be executed by a simple method.

Shape model generating unit 120 is configured to generate shape model MD2 that combines lower metallic mold 102 before pressing and workpiece W0, and generate shape model MD3 that combines lower metallic mold 102 after pressing and workpiece W1.

Shape models MD2, MD3 that combine lower metallic mold 102 and workpieces W0, W1, respectively, enable switching between the states of workpiece before and after pressing by a simple method. This can reduce the processing load of the simulation.

Shape model generating unit 120 is configured to generate a three-dimensional shape model of the press machine, the conveyance apparatus, and the workpiece.

Generating a three-dimensional shape model enables execution of a simulation process in a manner close to an actual machine. Thus, the accuracy in simulation is improved.

A simulation method according to an embodiment is a simulation method for simulating a conveyance line including a conveyance apparatus configured to convey a work between adjacent press machines. The simulation method includes: simulating the operations of each of the press machines, the conveyance apparatus, and the work; determining whether there is interference; generating shape model MD that combines feeder F and workpiece W; and switching between displaying/hiding of workpiece W in shape model MD. The determining of whether there is interference includes determining whether there is interference between shape model MD and the press machine and, when workpiece W is hidden, determining that there is no interference with workpiece W.

Generation of shape model MD that combines feeder F and workpiece W for determination of whether there is interference eliminates the need to independently define the operation of workpiece W separately from the operation of feeder F. Thus, the interference check for determining whether there is interference can be executed by a simple method.

A simulation program according to an embodiment is a simulation program executable on a computer (CPU 12) of simulation apparatus 10. The simulation program causes the computer to function as: operation simulation unit 122 configured to simulate the operations of each of the press machines, the conveyance apparatus, and the workpiece; interference check unit 124 configured to determine whether there is interference; shape model generating unit 120 configured to generate shape model MD that combines feeder F and workpiece W; and switching setting unit 126 configured to switch between displaying/hiding of workpiece W in shape model MD, as shown in FIG. 4. Interference check unit 124 is configured to determine whether there is interference between shape model MD and the press machine and, when workpiece W is hidden, determine that there is no interference with workpiece W.

Generation of shape model MD that combines feeder F and workpiece W for determination of whether there is interference eliminates the need to independently define the operation of workpiece W separately from the operation of feeder F. Thus, the interference check for determining whether there is interference can be executed by a simple method.

The embodiment disclosed herein is illustrative only, not limitative. It is intended that the scope of the present invention is defined by the terms of the claims and includes any modification within the meaning and scope equivalent to the terms of the claims.

### REFERENCE SIGNS LIST

1: press system; 2, 2A, 2B, 2C, 2D: press apparatus; 3, 3A, 3B, 3C, 3D, 3E, 3F: conveyance apparatus; 4A, 4B: servo amplifier; 5A, 5B: servo motor; 6A, 6B: position detection encoder; 9: controller; 10: simulation apparatus; 14: communication device; 16, 90: memory; 18: input device; 20: display device; 22: internal bus; 92: line synchronization controller; 94: press controller; 96: conveyance controller; 100: upper metallic mold; 102: lower metallic mold; 120: shape model generating unit; 122: operation simulation unit; 124: interference check unit; 125: command setting unit; 126: switching setting unit

1: A simulation apparatus configured to simulate a conveyance line including a conveyance apparatus configured to convey a work between adjacent press machines, the simulation apparatus comprising:
an operation simulation unit configured to simulate operations of each of the press machines, the conveyance apparatus, and the work;
an interference check unit configured to determine whether there is interference;
a shape model generating unit configured to generate a shape model that combines the conveyance apparatus and the work; and
a switching setting unit configured to switch between displaying/hiding of the work in the shape model,
the interference check unit being configured to determine whether there is interference between the shape model and the press machine and, when the work is hidden, determine that there is no interference with the work.

2: The simulation apparatus according to claim 1, wherein the interference check unit is configured to, when the work is displayed, determine whether there is interference with the shape model including the work.

3: The simulation apparatus according to claim 2, wherein the interference check unit is configured to, when a first conveyance apparatus carries the work into the press machine in a first conveyance line, determine whether there is interference between a first shape model in which the work is displayed, and the press machine.

4: The simulation apparatus according to claim 1, wherein the interference check unit is configured to, when a first conveyance apparatus removes from the press machine in a first conveyance line, determine whether there is interference between a first shape model in which the work is hidden, and the press machine.

5: The simulation apparatus according to claim 3, wherein the interference check unit is configured to, when a second conveyance apparatus enters the press machine in a second conveyance line different from the first conveyance line, determine whether there is interference between a second shape model in which the work is hidden, and the press machine.

6: The simulation apparatus according to claim 5, wherein the interference check unit is configured to, when the second conveyance apparatus carries the work out of the press machine in the second conveyance line, determine whether there is interference between the second shape model in which the work is displayed, and the press machine.

7: The simulation apparatus according to claim 5, wherein the work in the first shape model and the work in the second shape model are different from each other.

8: The simulation apparatus according to claim 1, wherein
the shape model generating unit is configured to generate a press shape model that combines the press machine and the work, and
the switching setting unit is configured to switch between displaying/hiding of the work in the press shape model.

9: The simulation apparatus according to claim 8, wherein
the shape model generating unit is configured to generate:
a first press shape model that combines the press machine before pressing and a first work; and
a second press shape model that combines the press machine after pressing and a second work.

10: The simulation apparatus according to claim 1, wherein the shape model generating unit is configured to generate a three-dimensional shape model of the press machine, the conveyance apparatus, and the work.

11: A simulation method for simulating a conveyance line including a conveyance apparatus configured to convey a work between adjacent press machines, the simulation method comprising:
simulating operations of each of the press machines, the conveyance apparatus, and the work;
determining whether there is interference;
generating a shape model that combines the conveyance apparatus and the work; and
switching between displaying/hiding of the work in the shape model,
the determining of whether there is interference including determining whether there is interference between the shape model and the press machine and, when the work is hidden, determining that there is no interference with the work.

12: A non-transitory storage medium encoded with a simulation program executed by a computer of a simulation apparatus configured to simulate a conveyance line including a conveyance apparatus configured to convey a work between adjacent press machines, the simulation program causing the computer to function as:
an operation simulation unit configured to simulate operations of each of the press machines, the conveyance apparatus, and the work;
an interference check unit configured to determine whether there is interference;
a shape model generating unit configured to generate a shape model that combines the conveyance apparatus and the work; and
a switching setting unit configured to switch between displaying/hiding of the work in the shape model,
the interference check unit being configured to determine whether there is interference between the shape model and the press machine and, when the work is hidden, determine that there is no interference with the work
